(19) United States
(12) Patent Application Publication
(10) Pub. No.: US 2023/0126338 A1
(43) Pub. Date: Apr. 27, 2023

(54) Reciprocating rotary masturbation cup

(71) Applicants: Zhubiao Shao, Shenzhen (CN); Zhutong Shao, Shenzhen (CN)

(72) Inventors: Zhubiao Shao, Shenzhen (CN); Zhutong Shao, Shenzhen (CN)

(21) Appl. No.: 18/146,391

(22) Filed: Dec. 26, 2022

(51) Int. Cl. A61H 19/00; H02K 7/14; H02K 7/116

(52) U.S. Cl. CPC A61H 19/32; H02K 7/14; H02K 7/116; A61H 2201/1215; A61H 2201/1671

(57) ABSTRACT

A rotary masturbation cup which is configured to reciprocate. The masturbation cup includes an upper shell and a lower shell releasably secured to the upper shell. Top of the upper shell is provided with a push-button. Inside of the upper shell is provided with a battery powered DC motor. A circuit board is electrically connected to the DC motor. The push-button is electrically connected to the circuit board. The DC motor is covered by upper and lower covers. An output end of the DC motor is provided with a transmission gear. Bottom of the lower cover of the DC motor is provided with a roller fastening member. The lower cover of the DC motor is threadedly secured to the roller fastening member. Top of the lower shell is provided with a reciprocating roller. A reciprocating massage sleeve is disposed on an inner surface of the reciprocating roller.

### FIELD OF THE INVENTION

The invention relates to vibrators and more particularly to a reciprocating rotary masturbation cup having improved characteristics.

### BACKGROUND OF THE INVENTION

In daily life, as people's pace of life accelerates, the pressure increases day by day, people's demand for relief is getting stronger and stronger, and at the same time with the diversification of social thinking, adult health care products are increasingly accepted, such as masturbation cup.

At present, many types of masturbation cups on the market use pure soft silica gel or rubber to imitate the shape of female sexual organs, and use electric or pneumatic methods to carry out rotating mechanical movement to massage male sexual organs. The function is monotonous and cannot simulate the real stretching and rotating experience, which reduces the user's sense of experience, not in line with the actual physiological needs of the human body, and most of the existing masturbation cups can only be driven from the center of the cup, making the product size is too high, and the structure is complex.

Thus, the need for improvement still exists.

### SUMMARY OF THE INVENTION

The purpose of the invention is to provide a reciprocating rotary masturbation cup to solve the problems raised in the above-mentioned background technology.

To achieve the above purpose, the invention provides the following technical solutions: The reciprocating rotary masturbation cup comprises an upper shell and a lower shell fixedly installed, the top of the upper shell is provided with a push-button, the interior of the upper shell is provided with a gearbox, the gearbox comprises an upper cover and a lower cover, the lower cover of the gearbox is provided with a DC motor, the output end of the gearbox is provided with a transmission gear, the bottom of the lower cover of the gearbox is provided with a roller fastening member, and the lower cover of the gearbox is fixed on the outside of the roller fastening member through screws, the top of the lower shell is provided with a massage component which is convenient for reciprocation and rotation.

Preferably, the upper cover of the gearbox and the lower cover of the gearbox are fixed and installed by screws, a sealing ring is arranged between the upper cover of the gearbox and the lower cover of the gearbox, and a motor fastener is arranged on the lower cover of the gearbox at one side of the DC motor.

Preferably, a circuit board and a battery are arranged internally between the upper cover and the lower cover of the gearbox, the circuit board is electrically connected to the battery, and the keys are electrically connected to the circuit board.

Preferably, the massage component comprises a roller, the roller is movably installed on the inner surface of the roller fastening member, the outer side of the roller is provided with a curved groove, and the roller fastening member is provided with a pin in the curved groove.

Preferably, a grooved gear is arranged at the outer side of the end of the roller, and the grooved gear and the transmission gear mesh with each other.

Preferably, the inner surface of the roller is provided with a reciprocating silicone massage sleeve, and the outer side of the roller is provided with a plurality of lengthwise ridges, which are movably secured to the grooved gear.

Compared with the conventional art, the invention has the following advantages:

The invention places the reducer motor on the outer side horizontal to the roller, and converts the rotation direction of the motor into the roller through the rotation gear, the guide groove of the gear and the curved groove of the roller, which can be reciprocated and rotated at the same time, so that the user can be more relaxed and stimulated, saving the product space, simple structure, high torque.

The above and other objects, features and advantages of the invention will become apparent from the following detailed description taken with the accompanying drawings.

### BRIEF DESCRIPTION OF THE DRAWINGS

FIG. 1 is a perspective view of a reciprocating rotary masturbation cup of the invention;

FIG. 2 is an exploded view of the reciprocating rotary masturbation cup;

FIG. 3 a longitudinal sectional view of the reciprocating rotary masturbation cup; and

FIG. 4 is a perspective view of some internal components of the reciprocating rotary masturbation cup.

### DETAILED DESCRIPTION OF THE INVENTION

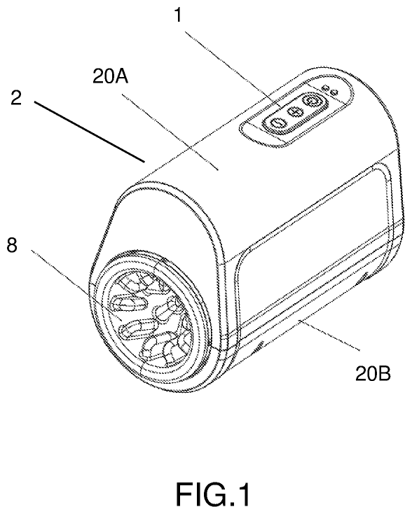

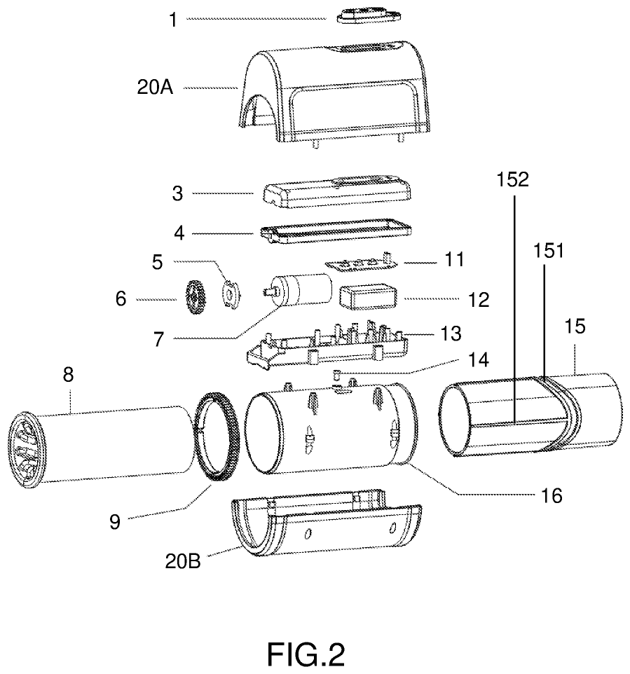

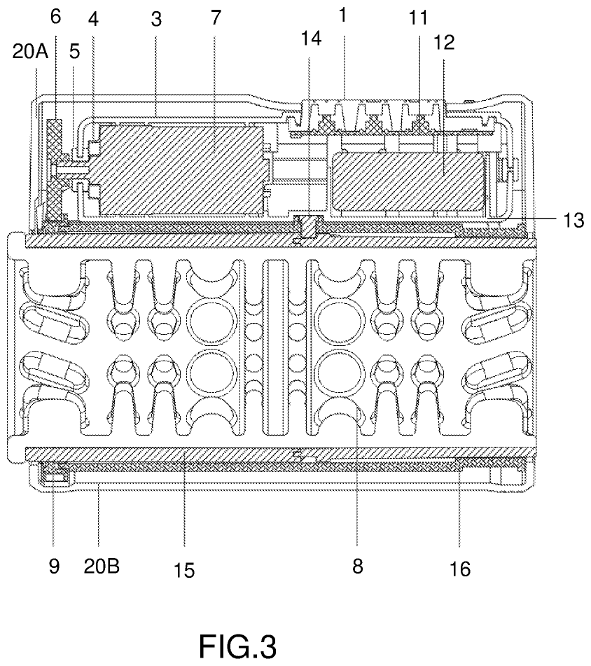

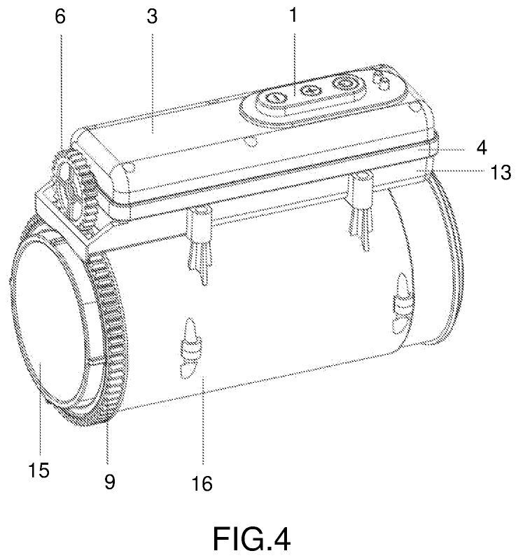

Referring to FIGS. 1 to 4, the invention provides a reciprocating rotary masturbation cup, which comprises a housing 2 including an upper shell 20A and a lower shell 20B which are fixedly installed to protect the internal transmission components, a push-button 1 is fixedly installed on the top of the upper shell 20A, a direct current (DC) motor 7 is installed inside the upper shell 20A, the DC motor 7 includes an upper cover 3 of the DC motor 7 and a lower cover 13 of the DC motor 7. The DC motor 7 is fixedly installed between the upper cover 3 of the DC motor 7 and the lower cover 13 of the DC motor 7 through screws.

A sealing ring 4 is bonded between the upper cover 3 of the DC motor 7 and the lower cover 13 of the DC motor 7 to ensure the safety of the internal parts between the upper cover 3 of the DC motor 7 and the lower cover 13 of the DC motor 7 and prevent water from affecting its work. The lower cover 13 of the DC motor 7 is fixed with a motor fastener 5 at one side of the DC motor 7. The motor fastener 5 is sleeved at the output end of the DC motor 7 and is adapted to prevent it from shaking inside.

A circuit board 11 and a battery 12 are arranged internally between the upper cover 3 of the DC motor 7 and the lower cover 13 of the DC motor 7. The circuit board 11 is electrically connected to the battery 12. The push-button 1 is electrically connected to the circuit board 11. The circuit board 11 is electrically connected to the DC motor 7. The output end of the DC motor 7 is provided with a transmission gear 6. The bottom of the lower cover 3 of the DC motor 7 is provided with a roller fastening member 16. The lower cover 13 of the DC motor 7 is fixed on the outside of the roller fastening member 16 through screws.

The top of the lower shell 20B is provided with a component which is convenient for reciprocation and rotation. The component is a reciprocating roller 15, which is movably installed on the inner surface of the roller fastening member 16. The outer surface of the reciprocating roller 15 is provided with a curved groove 151, and the roller fastening member 16 is fixed with a pin 14 which is located in the curved groove 151. The reciprocating roller 15 is movably installed on the inner surface of the roller fastening member 16 through the pin 14.

A grooved gear 9 is sleeved on a forward end of the reciprocating roller 15 and secured thereto, and the grooved gear 9 and the transmission gear 6 are engaged with each other. A reciprocating silicone massage sleeve 8 is secured to an inner surface of the reciprocating roller 15. The reciprocating silicone massage sleeve 8 is composed of a silicone cylinder and a convex head. A plurality of spaced lengthwise ridges 152 are formed on the outer surface of the reciprocating roller 15.

The lengthwise ridges 152 are movably secured to the grooved gear 9, and the grooved gear 9 is movably limited on the lower cover 13 of the DC motor reduction. In this embodiment, the rotation of the transmission gear 6 drives the rotation of the grooved gear 9, and the grooved gear 9 drives the rotation of the lengthwise ridges 152 and the reciprocating roller 15. With the cooperation of the curved groove 151 and the pin 14, the reciprocating roller 15 realizes reciprocation and rotation at the same time.

In actual use, press the push-button 1 to start the DC motor 7. The output end of the DC motor 7 rotates to drive the transmission gear 6. At this time, the rotation of the transmission gear 6 drives the rotation of the grooved gear 9, and the grooved gear 9 drives the rotation of the lengthwise ridges 152 and the reciprocating roller 15. With the cooperation of the curved groove 151 and the pin 14, the reciprocating roller 15 realizes reciprocation and rotation at the same time, and the reciprocating silicone massage sleeve 8 also realizes reciprocation and rotation at the same time, which makes the user more relaxed and stimulated. The overall reciprocation and rotation of the masturbation cup saves product space, with simple structure and large torque.

While the invention has been described in terms of preferred embodiments, those skilled in the art will recognize that the invention can be practiced with modifications within the spirit and scope of the appended claims.

What is claimed is:

1. A reciprocating rotary masturbation cup, comprising:
an upper shell; and
a lower shell releasably secured to the upper shell;
wherein a top of the upper shell is provided with a push-button, inside of the upper shell is provided with a DC motor, the DC motor includes an upper cover and a lower cover; and
wherein an output end of the DC motor is provided with a transmission gear, a bottom of the lower cover of the DC motor is provided with a roller fastening member, the lower cover of the DC motor is threadedly secured to the roller fastening member, and a top of the lower shell is provided with a reciprocating roller.

2. The reciprocating rotary masturbation cup of claim 1, wherein the upper cover of the DC motor and the lower cover of the DC motor are threadedly secured together, a sealing ring is disposed between the upper cover of the DC motor and the lower cover of the DC motor, and a motor fastener is disposed at a first side of the lower cover of the DC motor.

3. The reciprocating rotary masturbation cup of claim 1, further comprising a circuit board and a battery both disposed between the upper cover of the DC motor and the lower cover of the DC motor, wherein the circuit board is electrically connected to the battery, the circuit board is electrically connected to the DC motor, and the push-button is electrically connected to the circuit board.

4. The reciprocating rotary masturbation cup of claim 1, wherein the reciprocating roller is movably mounted on an inner surface of the roller fastening member, an outer surface of the reciprocating roller is provided with a curved groove, and the roller fastening member is provided with a pin partially disposed in the curved groove.

5. The reciprocating rotary masturbation cup of claim 4, further comprising a grooved gear secured to a forward end of the reciprocating roller, wherein the grooved gear meshes with the transmission gear.

6. The reciprocating rotary masturbation cup of claim 4, further comprising a reciprocating massage sleeve disposed on an inner surface of the reciprocating roller, and a plurality of lengthwise ridges formed on an outer surface of the reciprocating roller, the lengthwise ridges being movably secured to the grooved gear.
